(19) United States
(12) Patent Application Publication
(10) Pub. No.: US 2003/0081579 A1
(43) Pub. Date: May 1, 2003

(54) Apparatus and method for coupling a network data device to a digital network

(75) Inventors: Joseph Peter R. Tosey, N. Vancouver (CA); Richard Wodzianek, Coquitlam (CA)

Correspondence Address: Robert E. Krebs, Thelen Reid & Priest LLP, P.O. Box 640640, San Jose, CA, 95164-0640, US

(73) Assignee: Sierra Wireless, Inc., a Canadian Corporation

(21) Appl. No.: 10/208,152

(22) Filed: Jul. 29, 2002

Related U.S. Application Data
(60) Provisional application No. 60/330,694, filed on Oct. 29, 2001.

(51) Int. Cl. H04Q 7/24

(52) U.S. Cl. 370/338

(57) ABSTRACT

A network data device that receives data from an interconnected network is contemplated. The device has a processing circuitry, a data network connection circuitry for receiving data from the interconnected network, and a wireless messaging circuitry. The wireless messaging circuitry is communicatively coupled to the data network connection circuitry and the processing circuitry, and is responsive to a wireless signal. The data network connection circuitry is responsive to receive data from the interconnected network based upon an indication from the wireless messaging circuitry.

### RELATED U.S. PATENT APPLICATION DATA

The present non-provisional patent application is based on U.S. provisional patent application Serial No. 60/330,694, filed on Oct. 29, 2001.

### FIELD OF THE INVENTION

The invention relates to the field of digital data networks. More particularly, it relates to a system and method for enhancing the initiation of a wireless digital network device coupled to a wireless network.

### DESCRIPTION OF THE PRIOR ART

In many typical digital networks, an attached network device is coupled to the digital network through the use of a network address. When another device wishes to send or receive data from the device, a message to the device is initiated using the network address.

In some cases, the network device may become decoupled from the network. When this happens, messages to the device typically are sent to the old address, and when the device does not respond, the network mechanisms simply inform the sending device that the device cannot be found.

Mobile devices may use dynamic addresses supplied by some central server. When a device does not perform any network functions for a period of time, the device address may be “scrapped” from the address list. In this case, the address is lost through the network mechanisms themselves.

Sometimes, in the case of a mobile device, the device may go offline, or into a “sleep” mode. When the mobile device leaves the service area of a digital network, and into another network, the device may need a new address based on the change. In this case, messages sent to the old address will not find the proper device.

In another case, when a device goes into a quiescent state, even the data network activity may be sufficient to “rouse” the device in an inactive state. In any case, many times a network device enters a state where the address under which it was reachable previously may not be proper for current usage.

### SUMMARY OF THE INVENTION

In the invention, it is contemplated a method and apparatus for initiating a coupling of a network data device to a data network. In particular, a network data device receives data from an interconnected network. The network data device has a data network connection circuitry that allows it to send and/or receive data from the interconnected network. The network data device also has a wireless messaging circuitry, responsive to signals from a wireless message network. The data network connection circuitry is responsive to receive data from the interconnected network when the wireless messaging circuitry indicates that the device is to do so.

In an embodiment, the network data device operates in a number of states, one being a lower power state and another being a higher power state. While in the lower power state, the wireless messaging circuitry can receive messages from the wireless messaging network. In the higher power state the data network connection circuitry can receive and/or send messages from/to the interconnected data network

When a message from the wireless messaging network, through the wireless messaging circuitry, indicates that an event is pending on the interconnected network for the network data device, the device initiates a change in the power state from the lower power state to the higher power state.

The network data device can operate on a variety of interconnected networks. In one embodiment it operates on a TCP/IP protocol. The specific data network connection may be a wired or a wireless network protocol. Such protocols, including an 802.11 standard, a Bluetooth standard, a cable modem network interface, a DSL interface, are all exemplary embodiments, to name a few.

In another embodiment, the data network connection circuitry can be made of a plurality of data network connection circuitries. In this manner the network data device can selectively choose the particular connection to the interconnected network, based on one ore more criteria, or a number of them in conjunction.

The wireless messaging circuitry can operate on a low power wireless messaging protocol. These include paging protocols, and cellular phone protocols.

Methods of the operation of the data network device, as well as a server implementing the connection are also envisioned.

In one aspect, a server for coupling a network data device to an interconnected network is envisioned. The network data device has a wireless messaging circuitry and a data network connection circuitry. The server has a data network connection circuitry and a wireless messaging circuitry. The server has an address table that holds a network address. The network address is indicative of where to send data destined for the network data device. Circuitry in the server initiates contact with the network data device through the wireless messaging circuitries when the server cannot contact the network data device with the network address.

As such, a system and method for initiating a coupling of a network device to a data network is envisioned. Other novel features of the present invention will be apparent to those skilled in the art from the following detailed description of the invention, the appended claims, and in conjunction with the accompanying drawings.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block level diagram with a system having a wireless data device and connectivity accessories according to the invention.

FIG. 2 is a schematic block diagram depicting an exemplary embodiment detailing the ability to maintain the last contact with and providing new contact for the wireless data device of FIG. 1.

FIG. 3 is a schematic block diagram depicting an exemplary embodiment of the wireless data device of FIG. 1.

FIG. 4 is a signal-timing diagram of an embodiment of the invention described in the preceding figures.

FIG. 5 is an exemplary timing diagram of an initiation of an unreachable data network device, according to any of the preceding figures.

FIG. 6 is an exemplary timing diagram of an initiation of an unreachable data network device, when no network address server is used.

FIG. 7 is a flow diagram of an exemplary method on how a modified network address server or wireless server of FIG. 1 may operate.

FIG. 8 is a flow diagram indicating a possible method by which the data device of any of the preceding figures may operate when in an inactive mode.

### DETAILED DESCRIPTION OF THE PREFERRED EMBODIMENT

Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the description and the appended claims that follow.

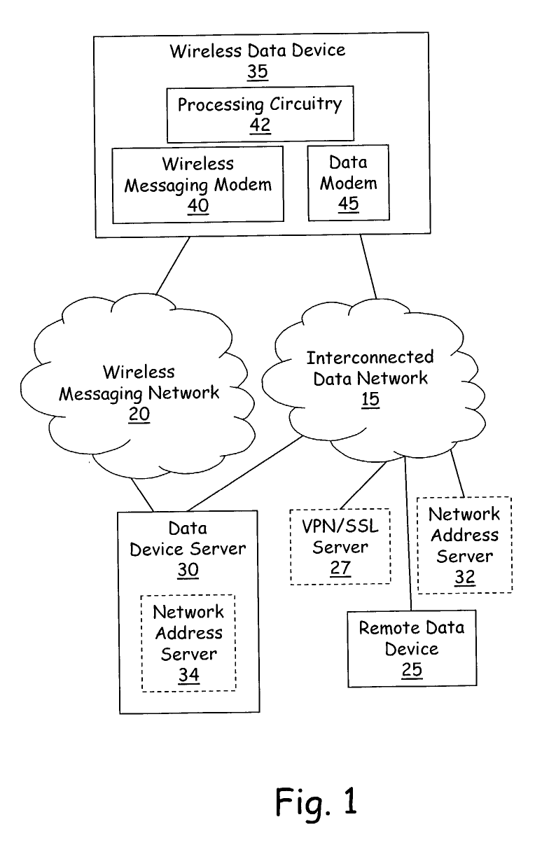

FIG. 1 is a block level diagram with a system having a wireless data device and connectivity accessories according to the invention. In a communication system 10, a remote data device 25 is coupled to a data network 15. The data network 15 is capable of passing data to any other device capable of receiving and processing such data. Typically, the data is passed in s on the data network 15.

The data device 25, in a typical operation, sends data through the interconnected data package network 15 to another device coupled to the interconnected network 15. The other device can then use such data in its operation.

Such an interconnected network can take many forms. In one case, the interconnected network operates on the TCP/IP protocol. Of course, many other protocols can be used in conjunction with the invention.

The interconnected network may be made up of other smaller networks that communicate to one another. In this case, the interconnected network can be such a network connection as exemplified by the Internet. Of course, localized versions may be envisioned, such as intranet coupling various local facilities, or coupling widespread

Such exemplary networks may also be thought of as local area networks, wide area network. Or, the networks may include portions that couple network devices in a secure manner, such as those found with Secure Socket Layer (SSL) protocols, or may be networked together in a virtual private network (VPN) type configuration.

Of course, while exemplary operation for this description is described in a context related to a TCP/IP protocol linked across the internet, many other methods of locating a particular address may be used instead, based on the network and the protocol. It should be noted, that while the descriptions of the devices in this specification are directed to a TCP/IP network connection, that the methods and apparatus described are able to be performed on any number of networks and/or network protocols.

Additionally, the interconnected network may be made up of any number of physical networking types. These include networks running on physical media, such a s telephone line, cable line, or optical lines. Networks may also include any number of wireless couplings, such as infrared, radio, or satellite network links. Exemplary embodiments of such wireless couplings include those defined under the various 802.11 standards, Bluetooth, or any other wireless network coupling.

The remote device 25 may be any number of exemplary devices. For example, the remote device 25 may be a computer. Such a computer may be a desktop model, laptop, or workstation. Other exemplary devices include network appliances, networked consumer devices, such as point of sale transaction devices, kiosks, or vending machines. Other network devices can include palm computing devices, or networked smart cards. Additionally, the exemplary devices may include network-assisting devices, such as servers, switches, routers, or hubs.

Of course, the foregoing devices are linked to the network through a network connection. This connection may take the form of any type of wired or wireless connection, or any form of protocol.

In the present embodiment, the remote data device sends data through the interconnected data network 15 to a data device 35. In an exemplary operation of the invention, the remote data device 25 first attempts to locate the data device 35 by using a universal resource locator (URL).

To accomplish this the remote data device 25 first initiates contact with a server capable of deciphering the URL into a network address. In this case, assume that the remote data device 25 sends the URL through interconnected data network 15 to a data device server 30.

For purposes of this diagram, assume that the wireless data device server 30 contains the functionally of a domain name server (DNS) 10. In this case the wireless data device server 30 translates the URL into a network address corresponding to the network address for the wireless data device 35.

A message for the wireless data device 35 is sent to the network address through the interconnected data network 15. Typically, the address is sent back to the remote data device first. Then, the remote data device 25 sends the appropriate data to the wireless data device 35 through the interconnected data network 15. In this manner, the data device server allows for a look up or a translation of the appropriate network address based upon the URL submitted.

After the translation of the URL into an appropriate network address, the remote data device 25 and the wireless data device 35 communicate normally through the interconnected data network 15. This is accomplished when the data device sends a message to the wireless data device, since a return network address is included in the message.

When the remote data device 25 or the data device 30 attempts to contact the wireless data device 35 through the interconnected network, the network address specifies that the data will flow through the interconnected network. The data is directed to the wireless data device 35 through a network data connection 40. The network data connection 40 couples the wireless data device 35 to the interconnected data network 15.

However, in some cases the wireless data device 35 may be disabled. For example, the wireless data device 35 may put itself into a sleep or inactive mode. Or, the wireless data device 35 may be active, although using a differing network address through another portion of the interconnected network. In this case, when the remote data device 25 sends the data through the interconnected data network 15 to wireless data device 35, there will be no valid or enabled device at the other end of the data stream.

In an embodiment of the invention, the wireless data device server 30 sends a test signal to the wireless data device 35 over the interconnected data network 15. This test signal could be many forms. In one embodiment, this test signal is in the form of a stateless IP-based query/response datagram protocol such as ICMP Ping or DNS Lookup. Any other protocol that generates some form of a packetized response maybe used.

If the wireless data device 35 is in a low power state, is asleep, is in an inactive state, or is otherwise non-responsive to the message over the interconnected data network 15, the wireless data device server will recognize this situation due to no response within some time.

If, after a predetermined amount of time, a response to the message sent to the wireless data device 35 has not arrived, the data device server 30 will time the request out. By the nature of the time out, the wireless data server 30 will assume that the wireless data device 35 is not able to receive messages since it has not responded.

In this case, the data device server 30 initiates a message to the wireless data device 35 over an existing wireless messaging network 20. Thus, the data device server attempts to contact the wireless data device 35 through the wireless messaging network 20 in order to find out if the wireless data packet device 35 is, in fact, able to respond to the request. Examples of the wireless messaging network 20 include any network using a conventional paging protocol, among others. These systems include such protocols as POCSAG, FLEX, ReFLEX, Mobitex, or a Short Message Service (SMS) paging channel integrated into PCS or satellite protocols, such as CDMA, GSM, Iridium, or Globalstar.

The message from the network data server 30 is a message that directs or causes the wireless data device 35 to initiate contact with either the wireless data device server 30 or the remote data device 25. In this sense, the message from the wireless messaging network can act a s a bootstrap signal, that allows the wireless data device 35 to initiate an on-demand coupling to the interconnected data network 15 without always having to consume power in maintaining the coupling to the data network 15.

The wireless data device 35 receives the message from the wireless data server 30 through a wireless messaging modem 40. Typically, this wireless message modem uses less power than the power used to couple the wireless data device 35 to the interconnected data network 15.

Upon receipt of the message from the wireless data server 30, the wireless data device 35 initiates a start up of operation to allow it to couple to and receive information from the interconnected data network 15. Upon such power up, or immediately prior to that power up, the wireless data device 35 may indicate its availability to the data device server 30. In one implementation, a processing circuitry 42 may perform a check on the message from the wireless data server. The processing circuitry may then determine whether the activation of the data network modem is needed.

In one example, the wireless data device 35 may respond to the “wake up signal” from the data device server 30. This can be accomplished through a responsive signal or other data sent from the data modem 45 contained within the wireless data device 35, through the interconnected data network 15, into the wireless data network 30. Alternatively, the wireless data device 35 may respond to such a “wake up” call through a return message through the wireless messaging network 20 using the wireless messaging modem 40.

In any case, the data device server 30 uses information that allows the initiation of the data stream between the remote data device 25 and remote data device 35. In one case, the wireless data device 35 sends its network address back to the data device server 30. If the address is new, or has changed from the one used previously, the data device server updates the appropriate information. The communication between the wireless data device 35 and the data server 30 may take place either over the data Network 15 or the wireless messaging network 20.

The data device server 30 can send the appropriate address to the remote device 25 to allow the data connection between the devices to proceed. In other cases, the network address of the wireless data device 35 may be sent to other devices, such as an SSL server, or a VPN server, to allow the appropriate functional network connection.

Of course, in other networking schemes, other steps can occur. This includes the wireless data device 35 sending the remote data device address information to establish the connection.

Specifically, as has been mentioned previously, initiation of the data coupling between the wireless data device 35 and remote data device 25 may be accomplished in several ways. For example, the wireless data device server 30, after receipt of an indication that the wireless data device 35 is in an active state, may then send to the remote data device 25 the returned network address for the wireless data device 35. In acknowledgment of the wireless data device 35, the remote data device 25 can then send the data to the wireless data device 35 through the interconnected data network 15.

It should be noted that the wireless messaging connection 40 to the wireless messaging network 20 consumes less power than the data network connection 45 to the data network 25. This allows for greater efficiencies in the battery life and connectivity of the wireless data device 35 to the data network 25, since less power is used in “do-nothing” periods. It also allows the wireless data device 35 to maintain contact to listen to events that cause initiation of a network data connection, rather than maintaining an “always on” data coupling. Thus, when the wireless data packet device 35 goes into an inactive state, the power expended in communicating with the wireless messaging network 20 is small relative to the power expended in communicating over the data network 15. The wireless data device 35 can enter into a low power state, allowing for continued connectivity over a lengthier time. Only when the device is needed will the more power hungry connection to the data network be utilized. This allows the device to always appear to be “on” or accessible to the interconnected data network.

Additionally, this helps alleviate problems with the problem of the wireless data device 35 being “dropped” from a network. Some wireless data devices enter a period of inactivity, and the address that the wireless data device 35 is assigned may be reassigned to some other device. In this case, messages destined for the wireless data device 35 may not be received when directed there.

Of course, this implementation correlates to a typical implementation of a data packet switched network, exemplified by one running a TCP/IP protocol. Any other protocols may be implemented in this scheme. Practitioners in networking should realize that many other transmission protocols may be implemented, and that the discussion related to the TCP/IP network above is exemplary only. The concepts can be extended to many other networking protocols. It should be noted that in the scenario detailed above, the function of the data device server 30 may be implemented in several coupled devices, such as a network address server 34, or an internal network address server 32. An exemplary network address server is such a device as a domain name server (DNS server), or the like.

In one example, the URL of the wireless data device 35 can be of the form joseph.sierrawireless.com. In this case the network address server will resolve the “sierrawireless” portion, and pass the “joseph” portion to the specialized server at sierrawireless.com. The server at sierrawireless.com can then map an appropriate address to the specific network device.

Or, the network address server and mapping functionality can take place at one particular device. The entire domain name can be mapped to a specific address by using one modified network address server.

The network address server may be implemented internally to the wireless data server, as shown in FIG. 1 as the network address server 34. Or, the functionality may be performed externally, depicted as the network address server 32.

The wireless data server 30 may operate in conjunction with an independent network address server 32. In this case, the network address server 32 is coupled to the interconnected data network 15. The remote data device 25 can initially contact the network address server 32 through the interconnected data network 15. The independent network address server 32 can then attempt to access the wireless data device 35 through the interconnected data network 15.

On a time out or other indication that the wireless data device 35 is not in an active mode, the network address server 32 can contact the data server device 30. Upon any indication that the wireless data device 35 was active, the data device server 30 would then attempt to initiate contact with the wireless data device 35 through the wireless messaging network 20.

The wireless data device 35 may then send its activation status back to the wireless data device server 30, which would then transfer the activation information to the network address server 32 through the interconnected data network 15. Or, the wireless data device 35 could contact the network address server 32 directly.

Or, upon a determination that the wireless data device 35 is enabled, the data server device 30 may send the appropriate information to the wireless data device 35. The transfer of the data from the wireless data device 35 to the wireless data server 30 may include transmissions through the wireless messaging network 20 or the interconnected data network 15. The wireless data server 30 can, in turn, send the appropriate information back to the network address server 32.

The network address server 32 can then contact the remote data device 25 with the information that the wireless data device 35 is ready to start communications with the remote data device 25. In an alternate embodiment, the wireless data device server may also send the appropriate address regarding the remote data device 25 to the wireless data device 35. In this case the wireless data device, upon initiation or placement into active mode would then answer to the remote data device 25 through the interconnected data network 15.

Thus, many possible transfers can be envisioned. The data device 35 can send its address, upon activation, to any of the components, including the DNS server 32, the wireless device server 30, or the remote device 25. The wireless device server 30 can send the address to the network address server 32 or the remote device 25.

A virtual private network (“VPN”) or secure socket layer (“SSL”) server 27 may also be used in the transmission of data between the data remote data device 25 and the wireless data device 35 in a secure manner. In a manner much as described above with respect to previous exemplary embodiments, the appropriate information may be transferred between the wireless data device 35 and the VPN/SSL server 27. This may be done to initiate a properly secure data link between wireless data device 35 and the remote data device 25 through the interconnected data network 15.

As can be surmised, the wireless data device 35 may also be mobile in nature. In this case the wireless data device's network address may or may not be the network address available to the network address server 32 or to the wireless data device server 30. In other words, when the wireless data device moves, its address may change. When the wireless data device is powered down, it may be unaware that it's previous coupling to the data network 20 is no longer valid. In this case, from the standpoint of the network at large, the previous address associated with the wireless data device 35 may be stale, or no longer valid.

Thus, when the remote data device 25 attempts to initiate contact with the wireless data device 35, the stale nature of the network address will not allow the wireless data device 35 to be found. For example, assume that the network address entry for the wireless data device 35 located in the network address server 32, or in an appropriate portion of the wireless data device server 30, is 100.100.100.100. The address is based on the wireless data device 35 having been previously coupled to the interconnected data device network 15.

The wireless data device 35 is then decoupled from the interconnected data network 15, either by moving or through entering into a non-active state. In some cases, such an assigned address may be dynamically re-assigned for numerous reasons. This is common in many internet protocol networks when a movable point of access is transferred between wireless networks, or when a point of access signs off of a hookup.

When the remote data device 25 attempts to contact the URL specified for the wireless data device 35, the reference in the network address server 32, or the wireless data device server 30, this can result in the message being sent to a possibly current invalid address for the wireless data device 35. In this case, the wireless data device server 30 can initiate contact with the wireless data device 35 through the wireless messaging network 20. Upon receipt of the message from the wireless data device server 30, the wireless data device 35 can initiate activation of a connection to the interconnected data network 15. During the course of this activation, a new network address may be assigned to the wireless data device 35.

Upon the assignation of the network address for the wireless data device 35, this information is conveyed to any of the wireless data device server, the network address server 32 or the VPN/SSL server 27, as is appropriate. In the case of the new address being sent to the wireless data server 30, this can occur through the use of either the wireless messaging network 20 or the interconnected data network 15.

Upon receipt of the new network address for the wireless data device 35, the appropriate information is relayed to the remote data device 25. This allows a completion of a data link between the wireless data device 35 and the remote data device 25.

As mentioned above, the specific mechanism involved in the initiation of communication between wireless data device 35 and the remote data device 25 may take many forms. As such the mechanisms mentioned above with respect to FIG. 1 is exemplary in nature, and any form of protocol through various devices may be used for specific embodiments.

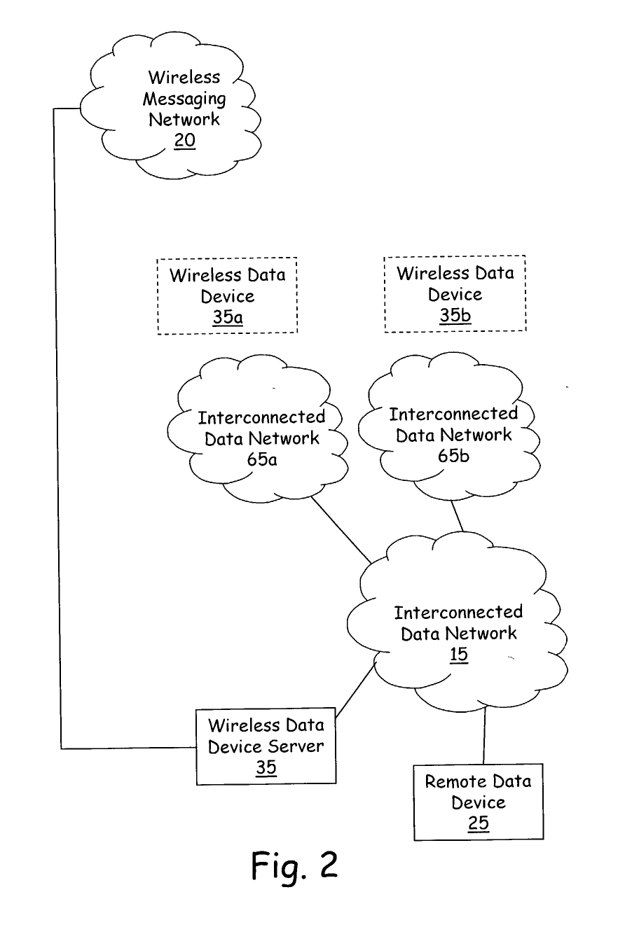

Accordingly, the embodiments of FIGS. 1 and 2 may be implemented without the network address server at all. In this case, the ability to contact the data network device 35 may be implemented in the remote network device. This presupposes that the remote network device will have the ability to contact an appropriate wireless message server to implement the appropriate initiation signal. Or, the ability to contact the data network device may reside in the wireless messaging server without the aid of a network address server.

FIG. 2 is a schematic block diagram depicting an exemplary embodiment detailing the ability to maintain the last contact with and providing new contact for the wireless data device of FIG. 1. In this case the remote data device 25 is coupled to the interconnected data network 15. The interconnected data network 15 may be thought of as several data networks coupled to one another. In this case the interconnected data network 15 has a communication coupling to a wireless interconnected data network 65b and another interconnected data network 65a.

At some previous point in time, the address information for the wireless data device 35 indicated a connection to the interconnected network 65a. Thus the information in the wireless data device 30, or independent network address server (not shown), indicates that the information is to be sent to the network address that indicated by the wireless data device 35a. The location of the wireless data device 35a indicates that the wireless data device is presently coupled to the interconnected data network 65a.

Upon the indication of some error in the initial transmission, the wireless data device server can initiate an activation signal through the wireless messaging network 20. This signal, as explained above and referenced in FIG. 1, alerts the wireless data device 35 that some remote data device is wishing to initiate contact with the wireless data device 35.

In this case assume that the physical location or logical location of the wireless data device 35 has changed from that indicated by the device 35a to that indicated by that of the wireless data device 35b. Upon receipt of the activation message from the wireless data device 30 through the wireless messaging network 20, the wireless data device 35, now at location 35b, initiates contact through the interconnected data network 65b. This communication in turn is directed to the interconnected data network 15 and eventually to either the wireless data device server 30 or the remote data device 25, as the case may be in a particular network protocol.

Of course, an additional device or devices may be involved with the process, as mentioned above. These include the possibility of a network address server, such as a DNS server. This network address server may be associated with the wireless data device server or as an independent unit. Other additional devices include a VPN/SSL server. Neither the VPN/SSL server nor the network address server are shown or depicted in FIG. 2.

It should be noted that the interconnected data network though which the wireless data device ultimately communicates with the remote data device 25 need not be a wireless interconnected data network. The interconnected network connections exist in many different forms, including hardwired portions, or wireless portions, as previously described. As detailed, the wireless data device 35 can communicate through any one or combination of the above mentioned wired or wireless physical standards. However, the present invention envisions that the wireless data device 35 is capable of being moved and such any such network may have the capability of assigning new network addresses based upon the movement of the specific device. Or, the network may be capable of reassigning network addresses after a predetermined period of time.

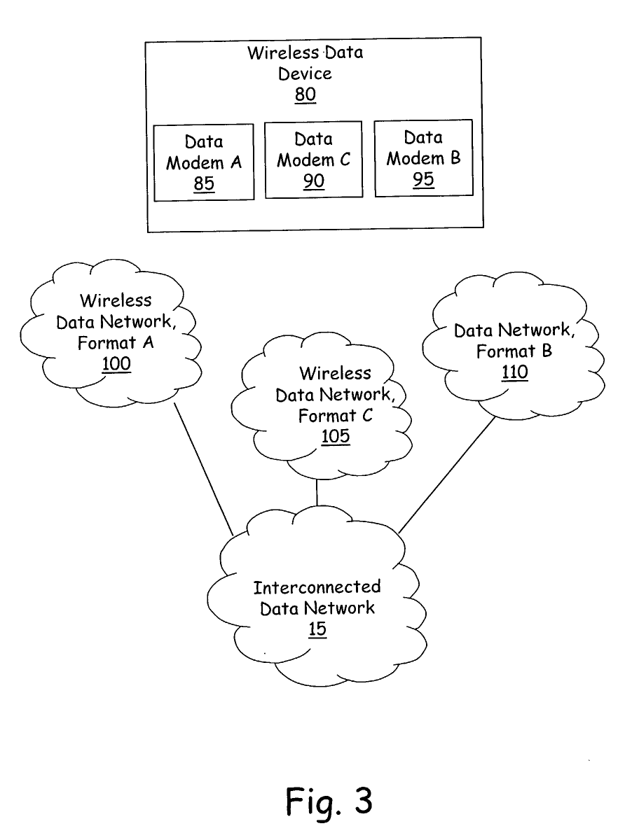

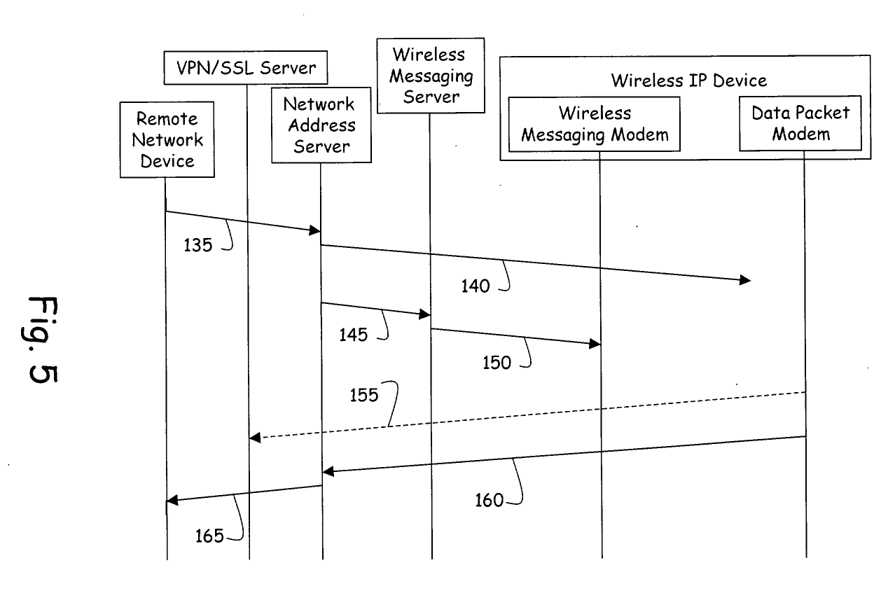

FIG. 3 is a schematic block diagram detailing an exemplary embodiment of the wireless data device of FIG. 1. A wireless data device 80 contains several different communication devices. These devices allow the wireless data device 80 to communicate with the interconnected network 15 over several different media, and/or with several different standards. Upon receipt of an activation signal from the device requesting the wireless data device 80 (the requesting device not shown in FIG. 5), the wireless data device 80 may determine that several alternative network attachments are available to it.

In particular, the wireless data device 80 contains a plurality of devices enabling the wireless data device 80 to communicate with the interconnected network 15. Each of the plurality of devices communicates with an interconnected network with a different medium and/or protocol. For example, the wireless data device 80 may contain a data modem A 85, a data modem B 95, and a data modem C 90. Each of the data modems enable the wireless data device 80 to communicate with the interconnected network and any devices attached to the interconnected network.

Assume that several differences formats and/or mediums for a network connection are available to couple the wireless data device 80 to the interconnected network 15. For example, assume that a wireless data network 100, a wireless data network 105 and a data network 110 are all available to communicate data to or from the wireless data device 80. For example the data device 80 may be a laptop computer, the wireless data network 100 may be a WI-FL wireless network running under an 802.11 standard, the wireless data network 105 may be an infrared network, such as that embodied by the Bluetooth standard, and the data network 110 may be one exemplified by communication thorough a DSL or cable modem physically coupled to the wireless data device 80.

Upon receipt of the activation signal, the wireless data device 80 determines the proper means of communicating the information to the interconnected network 15 and to the ultimate requesting recipient. This has been described above.

This determination may take place any number of ways. For example, if the wireless data device has information that it is plugged into steady electrical supply, such as an AC cord coupled to a wall socket, the wireless data device may initiate the data communication through the most reliable communication means available to it. In one case, any physical line terminated by the cable modem network may be the most reliable. Therefore, given a proper power supply, the wired connection, if available, may be chosen.

Or, assume that the wireless data device 80 is not physically coupled to any specific hard-wired network connection. In this case the wireless data device 80 may determine the best signal to noise ratio that the various wireless couplings have. The wireless data device 80 may make a determination based upon power levels, cost of connection, signal to noise ration, throughput, or any other criteria that maybe imagined. Thus, a predetermined criterion or choosing algorithm may be employed to determine the proper connection type.

These criteria need not be exclusive or used individually, but may be interrelated among one another. In this case, the choice is made between comparisons of combinations of the criteria, rather than comparisons of one criterion alone.

Or, the request to initiate contact with wireless data device 80 may contain some indication as to which network to apply through. In this case, the requester or some other network device can determine which network connection to use. Of course, the request may be one of a number of criteria used in the determination, singly or in combination.

As can be seen many different aspects of operation may be employed in the determination of the proper network through which the wireless data device 80 may respond to the initiating request. Further, the numbers of types of network connections are numerous, and the above example is exemplary in nature only. Any valid network connection that can be imagined may be used in the current implementation.

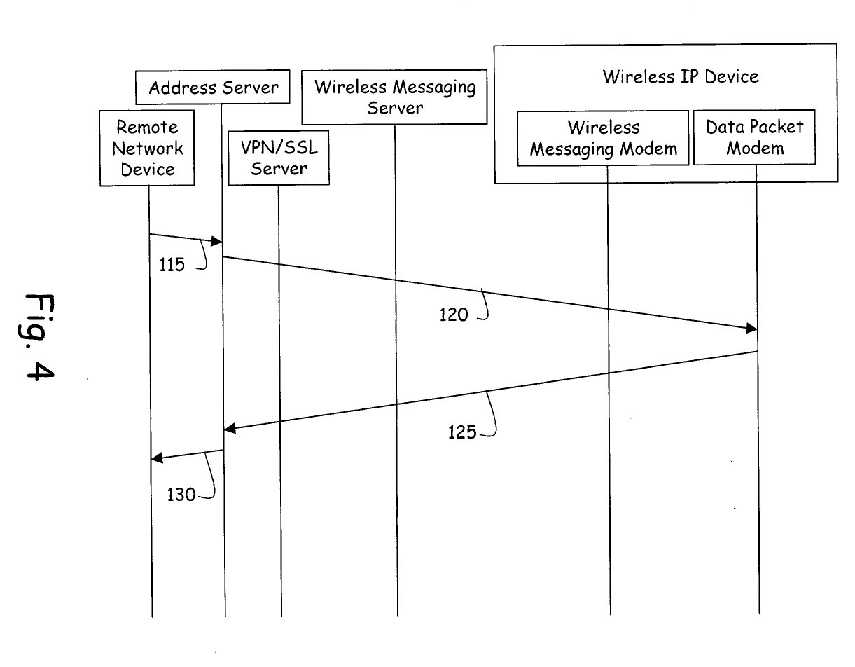

FIG. 4 is a signal-timing diagram of an embodiment of the invention described in the preceding figures. In this case a remote network device initiates a request to contact the wireless network device. The request travels from the remote device to the network address server through a communication 115. The network address server then attempts to initiate contact through the data network with the wireless network data device through a communication 120.

In the present example, the network data device is active, and receiving network data through a data modem. In this case, the communication 120 from the network address server reaches the wireless data network device via the communication 120 through the associated data modem.

The information or data is relayed to the wireless data network device, and processed. Upon completion of the processing of the communication 120, the wireless data device responds to the network address server through a communication 125. In turn the network address server communicates back to the remote network device in a communication 130. This communication indicates that the wireless network data device is able to initiate a data communication with the remote network device.

FIG. 5 is an exemplary timing diagram of an initiation of an unreachable data network device, according to any of the preceding figures. In this case, the remote network device initiates contact to the data network device with a communication to the network address server with a message 135.

The network address server responds to the communication 135 by attempting to contact the data network device at a specified network address with a communication 140. After asserting the communication 140, the request times out with no response from the data network device. Upon the timeout, or other indication that the data network device is currently unavailable, the network address server initiates a communication 145 to a wireless messaging server. The wireless messaging server then attempts to initiate contact with the network data device with a communication 150 over a wireless message network.

The network data device receives the message 150 from the wireless messaging server through a wireless message modem. Upon receipt of the communication 150, the data network device initiates an activation of its data network messaging abilities.

In one embodiment, the data network device then initiates a communication with a VPN/SSL server through a communication 155. Of course, this step is made to ensure that the security of the system is maintained. The step shown is optional, and is shown as an embodiment only.

After initiation of contact with the VPN/SSL server through the communication 155, the data network device responds to the network address server request through a communication 160. The network address server then relays the information to the remote network device through a communication 165. In this manner a network link between the remote network device and the wireless data network device is accomplished.

Of course, the different servers, may be VPN/SSL server, the network address server, and the wireless messaging server may be implemented on one platform, or the functionality of the devices may be spread across several platforms.

Additionally, the data network device may respond to the message server through the messaging network, or the data network device may respond to the message server, the network address server, or the remote device through the data network, as well as the embodiment detailed.

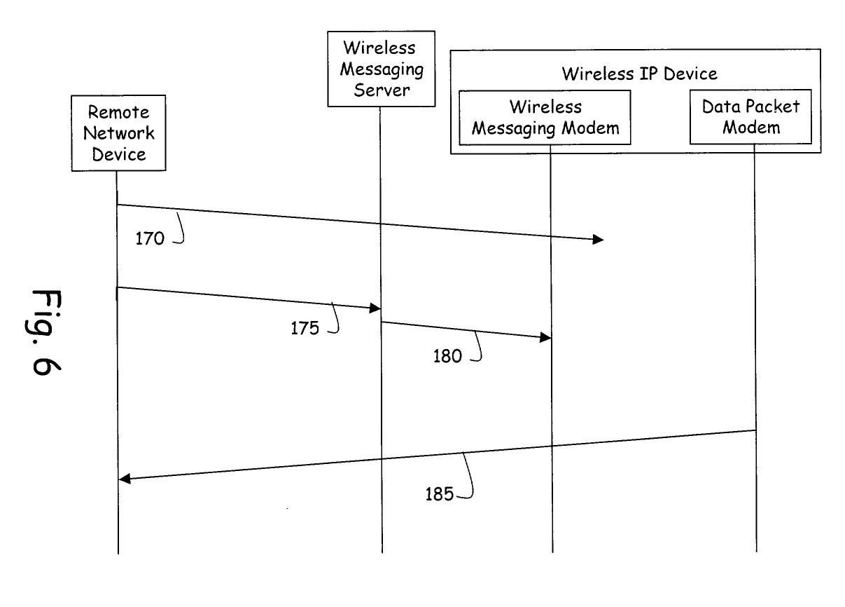

FIG. 6 is an exemplary timing diagram of an initiation of an unreachable data network device, when no network address server is used. In this case, the remote network data device initiates contact with a wireless network data device with a communication 170. After a timeout, the remote network data device then attempts to contact the wireless messaging server with a communication 175. The wireless messaging server then communicates to the wireless network data device with a communication 180.

In response, the wireless network data device then communicates to the remote network data device with a communication 185. In this manner, the data stream is established. It should be noted that the remote network data device may contact the wireless messaging server directly, and allow the wireless messaging server to attempt the communication to the wireless network data device over the data network, and to initiate the wakeup upon a timeout. Additionally, the wireless network data device may also respond to the wireless messaging server in response to the signal, rather than communicating directly to the remote network data device.

Each of the FIGS. 4, 5, and 6 can also be modified for when the data network device, as part of the initiation process, obtains a new network address. In this case the communication from the data network device requests such new address information. The contact through the wireless network or through the data network would, in turn, allow the data network device to communicate the newer or freshly obtained network address back to the appropriate network device.

The preceding messaging diagrams are all exemplary in nature. As such the specific network protocol maybe alterable, depending upon the different units involved and the specific network protocol used.

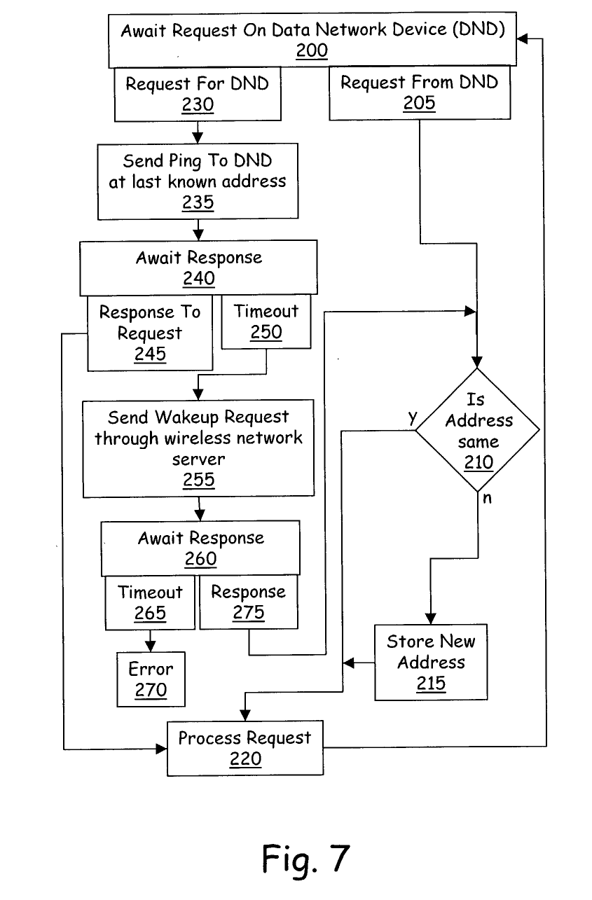

FIG. 7 is a flow diagram of an exemplary method on how a modified network address server or wireless server of FIG. 1 may operate in the context of the invention of any of the preceding figures.

In a block 200 the server awaits to request regarding a data device. In a block 205, a request is received from the data device. Upon the request coming in from the data device, the server determines whether the network address of the data device has changed.

In a step 210, the server determines if a network address exists for the data device, or whether the address is “stale”. If the determination is that the address of the data device is the same as previously, the server processes the appropriate request in a block 220 whereby the server device returns to the wait stage in the block 200.

In the block 210, if the device address has changed, or has been dropped, the server stores the new address. In this manner the server maintains the last known operating address of the data device. This storage occurs in a block 215. After the block 215, the server processes the request in the block 220, and then returns to the wait stage depicted by the block 200.

In a block 230, the wait stage of the server is interrupted by a request for a data device. In response to this request, the data device sends a test message to the data device at the data device's last known data network address in a block 235.

The server then awaits some response from the wireless data device in a block 240. In a block 245, the server receives a response from the data device over the data network. This response indicates that the last known address for the data device is a valid address. Upon the response of the data device to the server in block 245, the server returns to the wait stage 200 to await some new action on a data device.

If, however, the server does not receive a response to the message sent in the block 240, or receives some other indication that the data device is not at the specified address, the server then enters a block 250. In this case, the server sends an initiation or wake up request to the data device in a block 255.

After sending the wakeup request in the block 255, the server then awaits some response in a block 260. Upon a timeout or other indication of an error in a block 256, the server then enters an error state in a block 270.

This error state indicates that the data device, or for whatever reason is unavailable to the wireless network. This may mean that the data device is operational, but outside the range of wireless network, or may mean that the power to the wireless network device has ceased completely. Upon the entering into the error state indicated by the block 270 the server may do several different things. The server may indicate a specific re-try to the data device, attempting to initiate some kind of contact whenever the data device becomes available or, the server may simply “scrub” the entry for the particular data device from its table, allowing for more data devices to be entered.

In a block 275, the data device has responded. Control then flows to the block 215 where it is determined whether the returned network address is the same address as that stored in the server for contacting the data device through the interconnected data network.

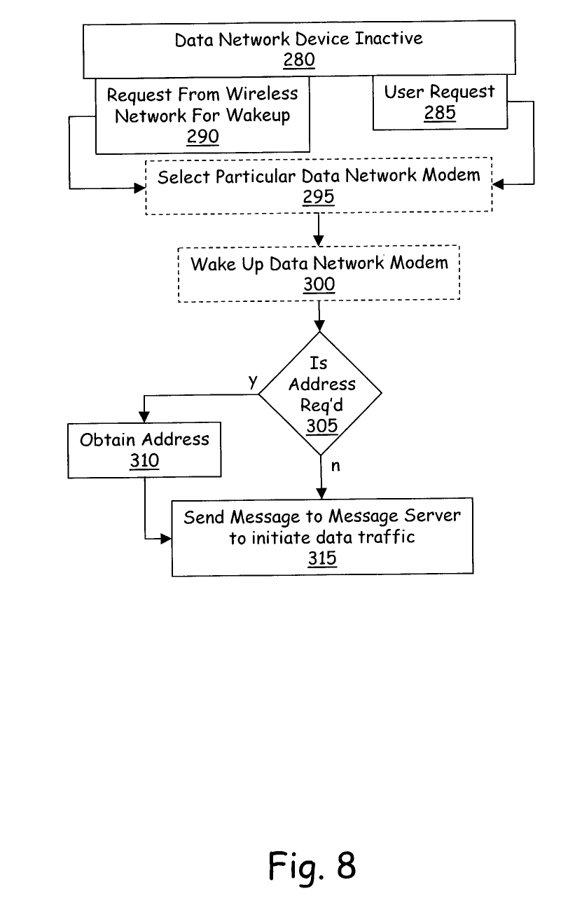

FIG. 8 is a flow diagram indicating a possible method by which the data device of any of the preceding figures may operate when in an inactive mode. In a block 280 the data device is in an inactive mode or quiescent state. In a block 290 and in a block 285 the data device is roused from the inactive state into an active state, where the data device will be used to communicate with a remote device over an interconnect network. Specifically the block 290 indicates the request for arousal coming from the wireless network, presumably from the wireless network server described above or, the network device may be awakened through a user request at the data device in the block 285.

In either case, control goes to a block 295. In a particular situation, a specific data network modem or transmissions is selected. This selection may be based on many different criteria, including reliability of the connection, power state, cost, a specification of the specific mode from the requestor or the device itself, or any other predetermined criteria, combination of predetermined criteria, or algorithm based on values of predetermined criteria. Of course, the block 295 is indicative of a data device having more than one data network connection. Of course, the case may exist that only one connection is available, thus making the execution of the step indicated in the block 295 superfluous.

In a block 300 the data device activates the particular network modem associated with the specific network in which it will be communicating with the remote network device through the interconnected network. Of course, the particular network modem may already be in operation and already be engaged in a link to the interconnect network. In this case the step represented by the block 300 is itself superfluous.

In a block 305, the data device determines whether a proper network connection is already in progress on the specified network connection. If an address is not needed, the data device sends a message to the message server, or the requesting device, or other server, that the data stream is ready to proceed. This occurs in a block 310.

If an address is required, the data device obtains one in a block 315. Control then flows to the block 310, where the data traffic is started.

The invention may be embodied, in whole or in part, on any computing device or software that runs on a computer. The invention may run on one computer as a monolithic process, or across computers as several different processes. The process or processes may be implemented on any combination of platform and operating system. It may be embodied in any combination of software or hardware, including running instructions from any computer readable medium.

Thus, a method and apparatus for initiating a digital Network device coupled to a wireless network is described and illustrated. Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the appended claims that follow.

We claim:

1. A network data device that receives data from an interconnected network, the device comprising:
a processing circuitry;
a data network connection circuitry for receiving data from the interconnected network;
a wireless messaging circuitry, communicatively coupled to the data network connection circuitry and the processing circuitry, the wireless messaging circuitry responsive to a wireless signal; and
the data network connection circuitry responsive to receive data from the interconnected network based upon an indication from the wireless messaging circuitry.

2. The network data device of claim 1 wherein the network data device is operable in a lower power state and a higher power state, the network data device:
while in the lower power state:
the wireless messaging circuitry is operable to receive messages;
while in the higher power state:
the data network connection circuitry is operable to receive messages from the interconnected data network;
the indication from the wireless messaging circuitry initiating a change in the power state from the lower power state to the higher power state.

3. The network data device of claim 1 wherein the interconnected network operates on a TCP/IP protocol.

4. The network data device of claim 1 wherein the data network connection circuitry operates according to a wireless network protocol.

5. The network data device of claim 4 wherein the wireless network protocol is an 802.11 protocol.

6. The network data device of claim 4 wherein the wireless network protocol is a Bluetooth protocol.

7. The network data device of claim 1 wherein the data network connection circuitry operates according to a wired network protocol.

8. The network data device of claim 1 wherein the data network connection circuitry is a plurality of data network connection circuitries.

9. The network data device of claim 8 wherein the network data device chooses to send data on one of the plurality of data network connection circuitries, the choice of the particular data connection circuitry based upon a predetermined criterion.

10. The network data device of claim 1 wherein the wireless messaging circuitry operates on a paging protocol.

11. The network data device of claim 1 wherein the wireless messaging circuitry operates on a cellular telephone protocol.

12. The network data device of claim 1 wherein the processing circuitry selectively enables the data network connection circuitry in response to the indication from the wireless messaging circuitry.

13. A server for coupling a network data device to an interconnected network, the network data device comprising a wireless messaging circuitry and a data network connection circuitry, the server comprising:
a data network connection circuitry, the data network connection circuitry operable to communicate with the network data device using a network address associated with the network data device;
a wireless messaging circuitry;
a circuitry for contacting the network data device through the wireless messaging circuitry;
the circuitry for contacting initiating a message to the network data device when the server cannot contact the network data device using the network address; and
the circuitry for contacting communicatively coupled to the data network connection circuitry, and the wireless messaging circuitry.

14. The server of claim 13 wherein the interconnected network operates on a TCP/IP protocol.

15. The server of claim 13 wherein the wireless messaging circuitry operates on a paging protocol.

16. The server of claim 13 wherein the wireless messaging circuitry operates on a cellular telephone protocol.

17. The server of claim 13 further comprising:
a domain name server.

18. The server of claim 13 wherein the server communicates the address to a requesting network device.

19. The server of claim 13 wherein the server overwrites the address with a new address after the network data device responds to the server contacting the network data device with the wireless messaging circuitry.

20. The server of claim 13 wherein the server assigns an address to the network data device after the network data device responds to the server contacting the network data device with the wireless messaging circuitry.

21. A method for communicatively coupling a network data device to an interconnected data network, the network data device comprising a wireless messaging circuitry and a data connection circuitry, the method comprising:
at the network data device, receiving a request to contact another device communicatively coupled to the wireless messaging circuitry, the wireless messaging circuitry operable in the low power state;
changing the power usage of the data connection circuitry from a low power usage state to a high power usage state, the high power usage state indicative of the data connection circuitry operable to communicatively couple to the interconnected data network;
sending data through the data connection circuitry to another device, the another device communicatively coupled to the network.

22. A method for obtaining a network address for a network data device, the network data device comprising a wireless messaging circuitry and a data connection circuitry, the method comprising:
at the network data device, receiving a request to contact a first device communicatively coupled to the wireless messaging circuitry, the wireless messaging circuitry operable in the low power state;
obtaining a network address from a second device communicatively coupled to the network data device, the network address an indicia to where other devices communicatively coupled to the interconnected data network can send data to the network data device;
sending data through the data connection circuitry to another device, the another device communicatively coupled to the network;

23. A method for registering a network address for a network data device, the network data device comprising a wireless messaging circuitry and a data connection circuitry, the method comprising:
at a wireless server, receiving a request to contact the network data device;
contacting the network data device through the wireless messaging circuitry, the wireless messaging circuitry operable in a low power state;
deriving a network address for the network data device;
registering the network address, such that additional requests for the network data device will be sent to the particular network address.
